(19) United States
(12) Patent Application Publication
(10) Pub. No.: US 2024/0028121 A1
(43) Pub. Date: Jan. 25, 2024

(54) Automated Adjustments of Haptic Feedback in Mobile Computing Devices

(71) Applicant: ZEBRA TECHNOLOGIES CORPORATION, Lincolnshire (IL)

(72) Inventors: Vattem Manohar Reddy, Gooty (IN); Gnana Prasad Reddy, Anantapur (IN)

(21) Appl. No.: 17/872,599

(22) Filed: Jul. 25, 2022

(51) Int. Cl. G06F 3/01; G06F 3/041; G06F 3/0488

(52) U.S. Cl. CPC G06F 3/016; G06F 3/0412; G06F 3/04166; G06F 3/0488; G06F 3/04847

(57) ABSTRACT

A computing device includes: a touch panel configured to detect touch input according to a set of touch panel modes defining distinct sensitivity levels; a motor configured to vibrate a housing of the computing device according to a configurable intensity level; a controller configured to: obtain an active one of the touch panel modes; determine, based on the active touch panel mode, an intensity level adjustment for the motor; and update the intensity level for the motor according to the intensity adjustment.

### BACKGROUND

Certain computing devices, e.g., handheld computers, are equipped with feedback mechanisms for generating notifications and/or feedback to operators of the devices. The conditions under which the computing device is operated, however, may interfere with the perception of some forms of feedback, such as haptic feedback generated via a motor of the computing device.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram illustrating a mobile computing device.

FIG. 2 is a schematic diagram illustrating certain components of the computing device of claim 1.

FIG. 3 is a flowchart of a method of automated adjustment of haptic feedback in computing devices.

FIG. 4 is a diagram illustrating an example performance of block 305 of the method of FIG. 3.

FIG. 5 is a diagram illustrating another example performance of block 305 of the method of FIG. 3.

FIG. 6 is a diagram illustrating an example performance of blocks 310 and 315 of the method of FIG. 3.

FIG. 7 is a diagram illustrating another example performance of blocks 310 and 315 of the method of FIG. 3.

FIG. 8 is a diagram illustrating an example adjustment interface for a haptic feedback intensity setting.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a computing device including: a touch panel configured to detect touch input according to a set of touch panel modes defining distinct sensitivity levels; a motor configured to vibrate a housing of the computing device according to a configurable intensity level; a controller configured to: obtain an active one of the touch panel modes; determine, based on the active touch panel mode, an intensity level adjustment for the motor; and update the intensity level for the motor according to the intensity adjustment.

Additional examples disclosed herein are directed to a method, including: obtaining an active one of a set of touch panel modes for a touch panel of a computing device, the touch panel modes defining distinct sensitivity levels; determining, based on the active touch panel mode, an intensity level adjustment for a motor of the computing device, the motor configured to vibrate a housing of the computing device according to a configurable intensity level; and updating the intensity level for the motor according to the intensity adjustment.

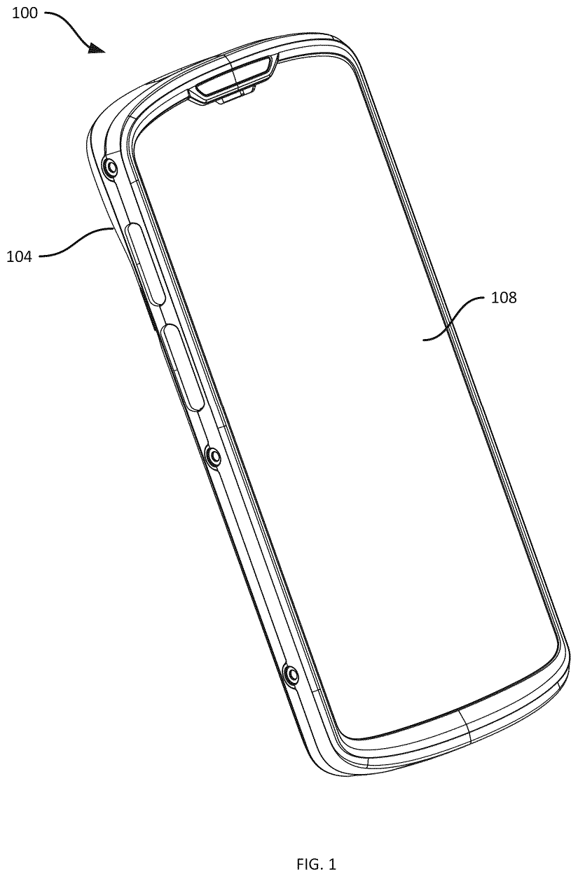

FIG. 1 illustrates a computing device 100. In the illustrated example, the computing device 100 is a handheld computing device (e.g., a smart phone or the like). In other examples, the computing device 100 can have various other form factors, including a tablet computer, a wearable device such as a smart watch or the like. The computing device 100 includes a housing 104 enclosing or otherwise supporting various other components of the device 100. The components of the device 100 supported by the housing 104 include a screen assembly 108, which can include a display and a touch panel, e.g., in a stacked arrangement. As will be evident, the screen assembly 108 can generate visual output in the form of graphics, text, and the like rendered via the display. The screen assembly 108 can also detect touch input, e.g., from an operator of the device 100, via the touch panel. The device 100 can also generate various other forms of output, including audible output via a speaker, auxiliary visual output via an indicator light (e.g., distinct from the display, or as a particular portion of the display).

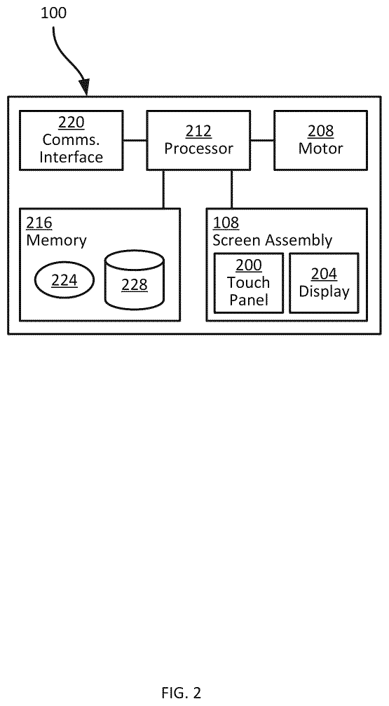

Turning to FIG. 2, a schematic diagram of certain components of the device 100 is shown. As seen in FIG. 2, the screen assembly 108 includes a touch panel 200 and a display 204, as mentioned above. In addition, the device 100 includes a motor 208 contained within the housing 104, activation of which enables the device 100 to generate haptic output. Activation of the motor 208 causes at least a portion of the outer surface of the device 100 (e.g., defined by the housing 104 and the screen assembly 108) to vibrate. The motor 208 can be activated to generate haptic output in response to a wide variety of events, including incoming calls and/or messages, as operator feedback in response to touch inputs detected by the touch panel, and the like.

The device 100 can be deployed in a wide variety of operating environments, including retail facilities, warehouse or other transport and logistics-related facilities, manufacturing facilities, and the like. In some operating environments, an operator of the device 100 may wear gloves or other coverings on their hands or fingers, e.g., for protection against abrasion, low temperatures, and the like. As will be evident, haptic output generated via the motor 208 may be less perceptible to the operator when wearing gloves than when the operator's hands are bare. Although the motor may be configurable to vibrate at different intensities, altering configuration settings each time the operator puts on or removes gloves may be inconvenient.

The device 100 therefore implements functionality to automatically adjust haptic output configuration under certain conditions. As will be described below in greater detail, the automatic adjustment of haptic output configuration is based at least in part on operating modes of the touch panel 200. As will be evident to those skilled in the art, the touch panel 200 can be implemented as a capacitive touch panel, configured to detect touch input via a change in capacitance over specific areas of the panel 200. For example, a finger contacting the outer surface of the screen assembly 108 can lead to an increase in detected capacitance at the area of the touch panel 200 underneath the finger. The magnitude of the increased capacitance, however, may vary depending on whether the finger is covered. For example, a bare finger may lead to a greater capacitance change than a gloved finger, because the glove places additional layer(s) of material between the touch panel 200 and the finger itself.

The touch panel 200 can apply a threshold to detected changes in capacitance, with changes exceeding the threshold being detected as touches, and changes falling below the threshold being ignored. Thus, the higher the threshold, the more likely the touch panel 200 is to ignore attempted touch input from a gloved operator. Conversely, the lower the threshold, the more likely the touch panel 200 is to erroneously detect inadvertent touch input, e.g., resulting from the operator hovering a finger over the screen assembly 108 without contact.

Each operating mode mentioned above is therefore defined by a distinct threshold, which can also be referred to as a sensitivity level. For example, the touch panel 200 can operate according to any of a stylus-oriented mode with a first threshold, a finger-oriented mode with a second threshold, and a glove-oriented mode with a third threshold. The third threshold can be higher than the second threshold, and the second threshold can be higher than the first threshold. The operating modes of the touch panel 200 can also be defined by other settings, such as threshold areas of contact for touch inputs. A wide variety of other sets of operating modes can also be implemented.

At any given time, the touch panel 200 operates in an active one of the available modes. The active mode can be selected by the operator, or determines automatically, as will be discussed below in greater detail. Since the operating modes of the touch panel 200 can be adapted to input modalities as mentioned above, the active operating mode provides an indication of the input modality that is likely being employed by an operator of the device 100. The device 100 can therefore be configured to use the active operating mode of the touch panel 200 to automatically adjust settings such as the intensity of the motor 208, to adapt those settings to the input modality.

As also illustrated in FIG. 2, the device 100 includes a processor 212, e.g., in the form of one or more central processing units (CPU), graphics processing units (GPU), or dedicated hardware controllers such as application-specific integrated circuits (ASICs). The processor 212 is communicatively coupled with a non-transitory computer-readable medium such as a memory 216, e.g., a suitable combination of volatile and non-volatile memory components. The processor 212 can also be communicatively coupled with a communications interface 220, such as a wireless transceiver enabling the device 100 to communicate with other computing devices via suitable network infrastructure. In other examples, however, the communications interface 220 can be omitted.

The memory 216 stores various computer-readable instructions executable by the processor 212, including a haptic feedback configuration application 224. Execution of the application 224 by the processor 212 configures the processor 212, in conjunction with the other components of the device 100, to automatically adjust the intensity level according to which the motor 208 operates. The memory 216 can also store configuration data 228 used during execution of the application 224. In some examples, configuration data 228 can be integrated into the application 224. Further, in some examples, the functions implemented via execution of the application 224 can be implemented via multiple distinct applications stored in the memory 216.

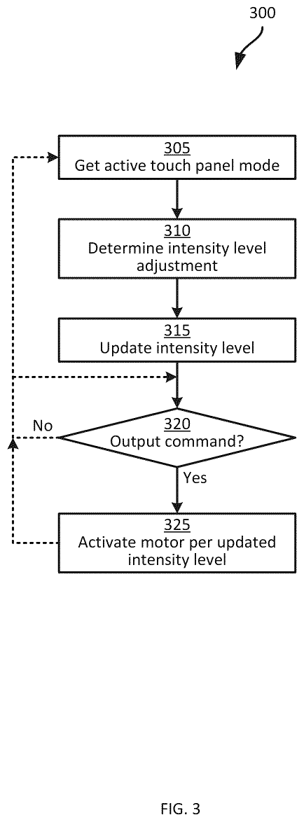

Turning to FIG. 3, a method 300 of automatic haptic feedback adjustment is illustrated. The method 300 will be described below in conjunction with its performance by the device 100, in particular via execution of the application 224 by the processor 212.

At block 305, the processor 212 is configured to obtain an active operating mode of the touch panel 200. The active operating mode can be stored in the memory 216 (e.g., in a portion of the repository 228 dedicated to runtime configuration settings). The active operating mode of the touch panel 200 can be altered via input data received at the processor 212, e.g., from the touch panel 200 itself. In other examples, the active operating mode of the touch panel 200 can be selected automatically by the processor 212 based on characteristics of touch inputs detected at the touch panel 200.

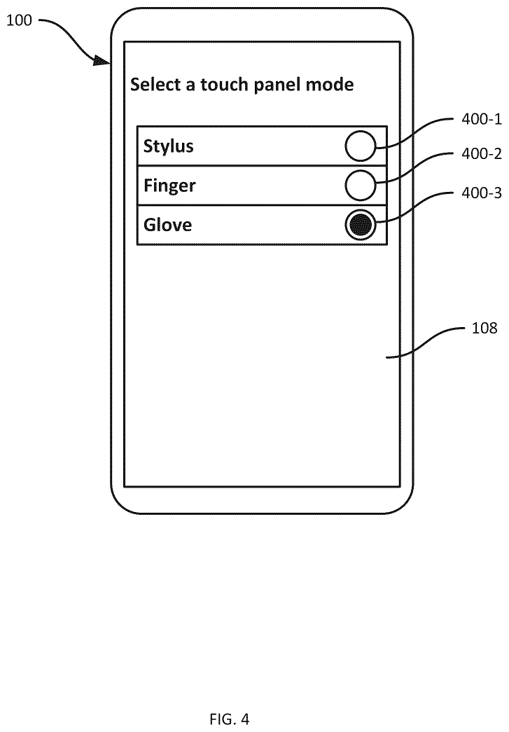

Turning to FIG. 4, an example implementation of a operator-driven selection of the active touch panel mode is illustrated. For example, the processor 212 can be configured to control the display 204 to render a prompt including selectable elements 400-1, 400-2, and 400-3, each corresponding to a distinct touch panel mode. In the illustrated example, the element 400-1 corresponds to a stylus-oriented mode, e.g., with an elevated capacitance threshold (that is, a relatively low sensitivity level). The element 400-2 corresponds to a finger-oriented mode, e.g., with a capacitance threshold lower than that of the stylus-oriented mode (that is, a greater sensitivity level than the stylus-oriented mode). The element 400-3 corresponds a glove-oriented mode, e.g., with a capacitance threshold lower than that of the finger-oriented mode (that is, a greater sensitivity level than the finger-oriented mode). A wide variety of other touch panel modes can also be implemented, as will be evident to those skilled in the art.

Following rendering of the elements 400, the touch panel 200 can receive a selection of one of the elements 400 (in FIG. 4, the element 400-3 has been selected), and the processor 212 is configured to set the corresponding touch panel mode as active, e.g., by updating the above-mentioned runtime configuration setting in the repository 228.

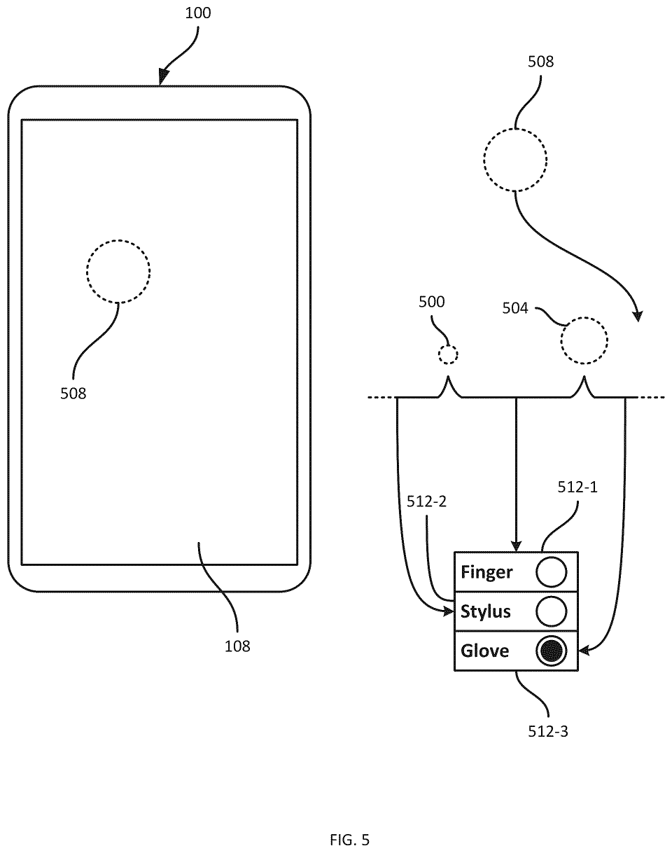

Turning to FIG. 5, the automatic selection of a touch panel operating mode by the processor 212 is illustrated. In the illustrated example, the application 224 or the repository 228 can define mode selection criteria, such as touch area thresholds. In this example, the mode selection criteria include a lower threshold 500, and an upper threshold 504, each defined as a radius, an area measurement, or the like. In response to detecting a candidate touch input 508 with a detected area (shown in dashed lines on the screen 108) via the touch panel 200, the processor 212 is configured to compare the detected area with the thresholds 500 and 504. The detected area of the candidate touch input 508 is an area of the touch panel 200 over which a detectable change in capacitance occurs (not necessarily a change that exceeds the sensitivity level of the current touch panel operating mode).

The thresholds 500 and 504 correspond to a set of touch panel operating modes 512-1, 512-2, and 512-3, corresponding respectively to the finger, stylus, and glove-oriented modes discussed above. For example, a detected touch input area below the lower threshold 500 corresponds to the stylus-oriented mode 512-2. A detected touch input area between the thresholds 500 and 504 corresponds to the finger-oriented mode 512-1, and a detected touch input area exceeding the upper threshold 504 corresponds to the glove-oriented operating mode 512-3. In the illustrated example, the area of the candidate touch input 508 exceeds the upper threshold 504, and the processor 212 is therefore configured to set the glove-oriented operating mode 512-3 as the active operating mode of the touch panel 200.

Returning to FIG. 3, having obtained the currently active touch panel mode at block 305, at block 310 the processor 212 is configured to determine an intensity level adjustment for the motor 208, based on the active touch panel operating mode. The repository 228 can contain a mapping of intensity level adjustments to touch panel operating modes. In some examples, each touch panel operating mode can be mapped to a corresponding intensity level adjustment. In other examples, some operating modes need not have corresponding intensity level adjustments. As will be evident, in the latter case no adjustment to the intensity level for the motor 208 is made when a touch panel mode is active that does not have a corresponding intensity level adjustment in the repository 228. Having determined an intensity level adjustment at block 310, the processor 212 is configured to update the intensity level at block 315, according to the determined adjustment.

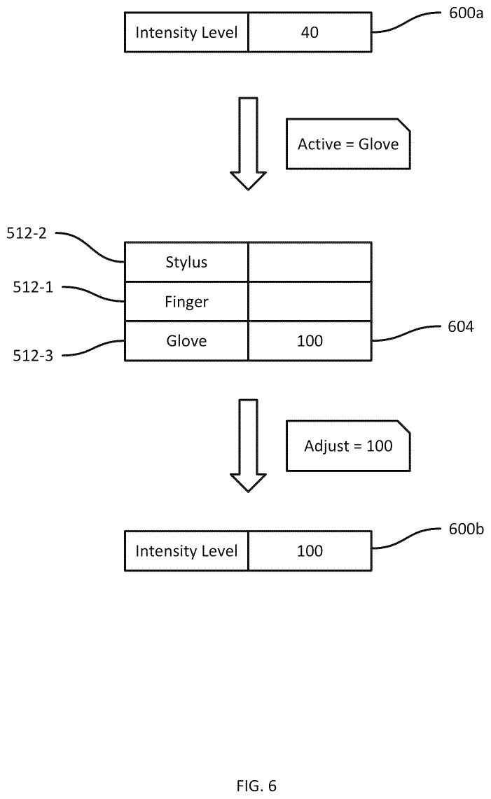

Turning to FIG. 6, an example determination of an intensity level adjustment is illustrated. In this example, the repository 228 contains a current intensity level setting 600a used to activate the motor 208. The intensity level 600a is shown as a numerical value between zero and one hundred, but a wide variety of other value types and ranges can also be employed.

The repository 228 also contains, in connection with at least a subset of the operating modes 512, an intensity level adjustment. In the illustrated example, an intensity level adjustment 604 is stored in connection with the mode 512-3, and no adjustments are stored in connection with the modes 512-1 and 512-2

The processor 212 is configured to query the adjustments in the repository 228 using the currently active touch panel operating mode (e.g., the glove mode 512-3 as illustrated). As will be evident, when the modes 512-1 and 512-2 are active, no adjustment to the setting 600a is performed. When the mode 512-3 is active, as in the current example, the processor 212 is configured to retrieve the adjustment 604, and apply the adjustment 604 to update the setting 600a, resulting in an updated intensity level setting 600b.

In the example of FIG. 6, the adjustment 604 is an absolute value, and applying the adjustment 604 to the setting 600a includes replacing the setting 600a with the value specified in the adjustment 604, such that the setting 600b contains the same value as the adjustment 604. In this example, that is, when the touch panel 200 is in the glove-oriented operating mode 512-3, the intensity level setting of the motor 208 is set to a maximum intensity (100, in this case) at block 315.

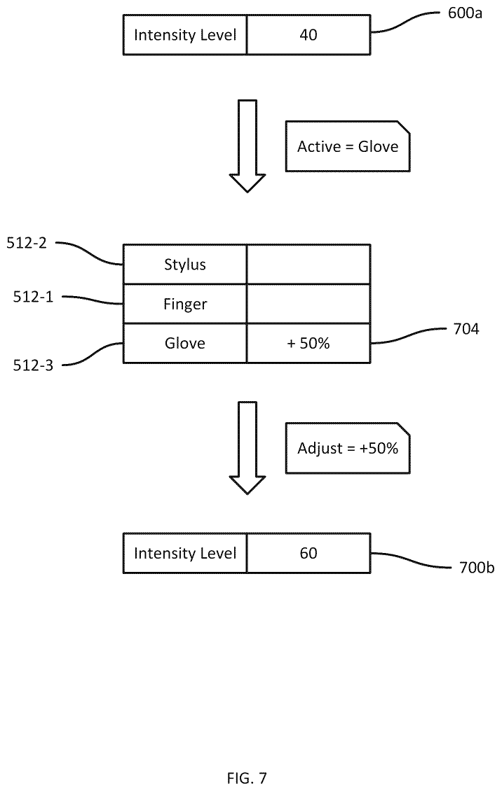

In other examples, as illustrated in FIG. 7, an adjustment 704 can be stored in connection with the mode 512-3 that defines an intensity modulation. That is, the adjustment 704 can specify an increment or decrement, rather than a replacement. In the illustrated example, the adjustment 704 indicates an increment of 50% of the current intensity level 600a, and application of the adjustment 704 therefore generates an updated intensity level setting 700b of 60 (i.e., 50% greater than the previous setting of 40) at block 315. In some examples, increments or decrements can be specified in absolute terms (e.g., adding or subtracting a specific value to the current setting 600a).

As will be evident to those skilled in the art, the types of adjustments shown in FIGS. 6 and 7 can also be used alongside one another. For example, the mode 512-1 can include an incremental adjustment such as that shown in FIG. 7, while the mode 512-3 can include a replacement adjustment such as that shown in FIG. 6.

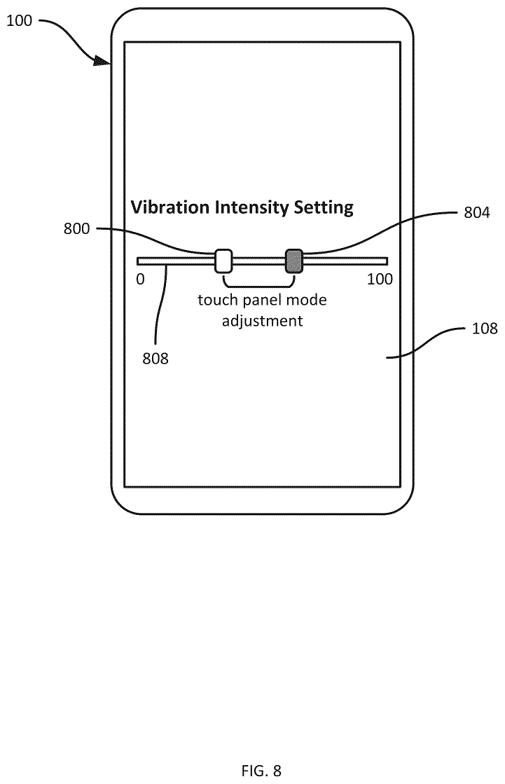

The intensity level settings 600b or 700b can also, in some examples, be accessed and modified manually by an operator of the device 100. In such examples, the processor 212 can be configured to prompt the operator for confirmation that the operator intends to override the touch panel mode-based adjustment before enabling manual reconfiguration of the intensity level setting. In other examples, as shown in FIG. 8, the processor 212 can maintain the unmodified setting (e.g., the setting 600a), and generate a reconfiguration interface that illustrates both the unmodified setting and the adjusted setting, e.g., via sliders respective 800 and 804 on a bar 808. The slider 800 may be manually adjusted, e.g., via interaction with the touch panel 200, and the processor 212 can automatically adjust the position of the slider 804 according to the underlying adjustment (e.g., the adjustment 704) to illustrate the effect of the manual adjustment on the actual intensity to be employed.

Returning to FIG. 3, at block 320 the processor 212 can determine whether an output command corresponding to the motor 208 has been received, e.g., as a result of an incoming message or other event. Such commands can be generated by other applications executed by the processor 212, in some examples. When the determination at block 320 is negative, the processor 212 can continue to monitor for output commands, and/or return to block 305, if a change in touch panel operating mode is detected. When the determination at block 320 is affirmative, the processor 212 is configured to activate the motor 208 according to the updated intensity level resulting from the performance of block 315.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A computing device, comprising:
a touch panel configured to detect touch input according to a set of touch panel modes defining distinct sensitivity levels;
a motor configured to vibrate a housing of the computing device according to a configurable intensity level;
a processor configured to:
obtain an active one of the touch panel modes;
determine, based on the active touch panel mode, an intensity level adjustment for the motor; and
update the intensity level for the motor according to the intensity level adjustment;
wherein the intensity level adjustment is an intensity modulation; and
wherein the processor is configured to update the intensity level by incrementing or decrementing the intensity level according to the intensity modulation, wherein the intensity modulation is a pre-set percentage change.

2. The computing device of claim 1, wherein the processor is further configured to:
obtain an output command; and
control the motor to vibrate the housing according to the updated intensity level.

3. The computing device of claim 1, wherein the touch panel is integrated with a display; and
wherein the processor is further configured to obtain an active one of the touch panel modes by:
controlling the display to render a prompt including the touch panel modes; and
receiving a selection of the active touch panel mode.

4. The computing device of claim 1, wherein the processor is further configured to obtain an active one of the touch panel modes by:
detecting a candidate touch at the touch panel;
comparing an area of the candidate touch with a threshold; and
selecting the active touch panel mode based on the comparison.

5. The computing device of claim 4, wherein the touch panel modes include a first mode with a first sensitivity, and a second mode with a second sensitivity greater than the first sensitivity; and wherein the processor is configured, when area of the candidate touch exceeds the threshold, to select the second mode.

6. The computing device of claim 1, further comprising a memory storing, in association with a first one of the touch panel modes, the intensity level adjustment; and
wherein the processor is configured to determine the intensity level adjustment by retrieving the intensity level adjustment from the memory when the first touch panel mode is active.

7. (canceled)

8. (canceled)

9. The computing device of claim 1, wherein the processor is further configured to:
store the intensity level and the updated intensity level; and
render an adjustment interface including graphical elements for each of the intensity level and the updated intensity level.

10. The computing device of claim 9, wherein the processor is further configured to:
receive input data modifying a position of the graphical element for the intensity level; and
update a position of the graphical element for the updated intensity level.

11. A method, comprising:
obtaining an active one of a set of touch panel modes for a touch panel of a computing device, the touch panel modes defining distinct sensitivity levels;
determining, based on the active touch panel mode, an intensity level adjustment for a motor of the computing device, the motor configured to vibrate a housing of the computing device according to a configurable intensity level; and
updating the intensity level for the motor according to the intensity adjustment;
wherein the intensity level adjustment is an intensity modulation; and
wherein updating the intensity level includes incrementing or decrementing the intensity level according to the intensity modulation, wherein the intensity modulation is a pre-set percentage change.

12. The method of claim 11, further comprising:
obtaining an output command; and
controlling the motor to vibrate the housing according to the updated intensity level.

13. The method of claim 11, wherein the touch panel is integrated with a display; and
wherein the method further comprises obtaining an active one of the touch panel modes by:
controlling the display to render a prompt including the touch panel modes; and
receiving a selection of the active touch panel mode.

14. The method of claim 11, wherein obtaining an active one of the touch panel modes includes:
detecting a candidate touch at the touch panel;
comparing an area of the candidate touch with a threshold; and
selecting the active touch panel mode based on the comparison.

15. The method of claim 14, wherein the touch panel modes include a first mode with a first sensitivity, and a second mode with a second sensitivity greater than the first sensitivity; and wherein the method comprises, when area of the candidate touch exceeds the threshold, selecting the second mode.

16. The method of claim 11, further comprising:
storing, in a memory of the computing device, the intensity level adjustment in association with a first one of the touch panel modes; and
determining the intensity level adjustment by retrieving the intensity level adjustment from the memory when the first touch panel mode is active.

17. (canceled)

18. (canceled)

19. The method of claim 11, further comprising:
storing the intensity level and the updated intensity level; and
rendering an adjustment interface including graphical elements for each of the intensity level and the updated intensity level.

20. The method of claim 19, further comprising:
receiving input data modifying a position of the graphical element for the intensity level; and
updating a position of the graphical element for the updated intensity level.
